(19) United States
(12) Patent Application Publication
(10) Pub. No.: US 2004/0073492 A1
(43) Pub. Date: Apr. 15, 2004

(54) Techniques for building construction and marketing

(76) Inventor: Charles Francis Griffin, Indialantic, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 10/348,616

(22) Filed: Jan. 21, 2003

Related U.S. Application Data
(60) Provisional application No. 60/350,349, filed on Jan. 24, 2002.

(51) Int. Cl. G06F 17/60

(52) U.S. Cl. 705/26

(57) ABSTRACT

Systems and techniques enable a “Do-It-Yourself” customer to successfully undertake construction of a substantial structure. Construction documentation is prepared that is ready for permitting and provided to the customer. The construction documentation is marketed in conjunction with a building supply outlet. Everything needed for construction is available from the building supply outlet. Lots suitable for construction are also available. A computer system containing the construction documentation can be linked to a computer system of the building supply outlet to allow immediate access to availability and pricing information to enable a contract to be printed with total pricing for the construction. Training, subcontractor relationships and financing are also available to the customer.

### CROSS REFERENCE TO RELATED APPLICATIONS

This application is related to and claims priority from U.S. Provisional Application Serial No. 60/350,349, filed Jan. 24, 2002, by Griffin, entitled: Techniques for Building Construction and Marketing, the contents of which are incorporated herein by reference in their entirety.

© Easy Build Structures, Inc. 2003

A portion of the disclosure of this patent document contains material that is subject to copyright protection. The copyright owner has no objection to the facsimile reproduction by anyone of the patent document or the patent disclosure as it appears in Patent and Trademark Office patent file records, but otherwise reserves all copyright rights whatsoever.

### REFERENCE TO A COMPUTER PROGRAM LISTING

This application contains a computer program listing on CD-ROM that is hereby incorporated by reference in to the specification of this application in its entirety.

### BACKGROUND OF THE INVENTION

1. Field of the Invention

The invention relates to techniques for building construction and marketing, and, more particularly, to techniques and computer assisted techniques for enabling a “Do-It-Yourself” customer to successfully undertake construction of a substantial structure.

2. Description of Related Art

Building techniques and kits for building construction are known. For example, U.S. Pat. No. 4,115,967, which issued on Sep. 26, 1978, and U.S Pat. No. 4,179,788, which issued on Dec. 25, 1979, both to inventor Gerald A. Kragt describe a building construction technique and a kit for constructing a building. In particular, these patents describe a building assembled using front and rear end panels connected by purlins extending between the end panels to support the roof structure. This particular construction obviates the necessity of accurately constructed rafter sub-assemblies.

The construction of substantial structures such as homes, barns, sheds and the like can be overwhelming to a “Do-It-Yourself” customer who has none or little experience in the construction industry. The obstacles of merely starting the process can be overwhelming. The building must be designed, the plans for the building drawn up certified and permits from local governments must be obtained. To a “Do-It-Yourself” customer, fear of the unknown, fear of the costs and fear of the challenge associated with such a sophisticated construction process can be overwhelming.

### BRIEF SUMMARY OF THE INVENTION

The techniques of the invention overcome the problems in the prior art by providing a complete package of information and supplies such that the “Do-It-Yourself” customer can, with limited background and training, successfully undertake construction of a sound and attractive structure.

In accordance with one aspect of the invention, a complete in stock system is provided so that the “Do-It-Yourself” customer or even a contractor can obtain everything needed for the construction of a building or structure from a single source.

The use of standardized components can result in lower cost for the overall structure than would otherwise be available in the course of a construction project unassisted by the techniques of this invention. Training can be provided to the “Do-It-Yourself” customer to supplement areas in which his skills might be weak.

In one aspect of the invention, the engineering design planning and permitting package is marketed in conjunction with a building supply outlet, such as a Home Improvement Center or chain of Home Improvement Centers, which provide everything needed for construction from a single source. This has the advantage of enabling a new class of customer for the building supply outlets while at the same time enabling the “Do-It-Yourself” customer to under take projects of substantial complexity at lower cost.

### BRIEF DESCRIPTION OF THE DRAWINGS

The techniques of the invention are described more hereinafter with reference to the following drawings, in which:

FIG. 1 is a perspective view of an exemplary building or structure that can be acquired and constructed in accordance with one aspect of the invention.

FIG. 2 is an exemplary floor plan of the exemplary building of FIG. 1.

FIGS. 3A, 3B and 3C are respective rear, left and right elevation views of the exemplary building of FIG. 1.

FIG. 4 is a high level flow chart of an exemplary process for enabling building construction for a customer in accordance with one aspect of the invention.

FIG. 5 is a flow chart of a process for carrying out step 435 of FIG. 4.

FIG. 6 is an exemplary network architecture in accordance with one aspect of the invention.

FIG. 7 is an exemplary computer architecture for use in implementing a kiosk or a corporate computer.

FIG. 8 is an exemplary package of materials provided to a customer for construction of a building or structure such as that shown in FIG. 1.

FIG. 9 illustrates an exemplary database containing information on a plurality of structures and certain views of data contained in a structure's information stored in the database.

FIGS. 10A, 10B, 10C, 10D and 10E are respective examples of data views used in different reports taken from the database illustrated in FIG. 9.

FIG. 11 is a flow chart of an exemplary delivery schedule for materials needed to build a structure in accordance with one aspect of the invention.

FIG. 12 is a flow chart of an exemplary process for opening a new store.

### DETAILED DESCRIPTION OF THE INVENTION

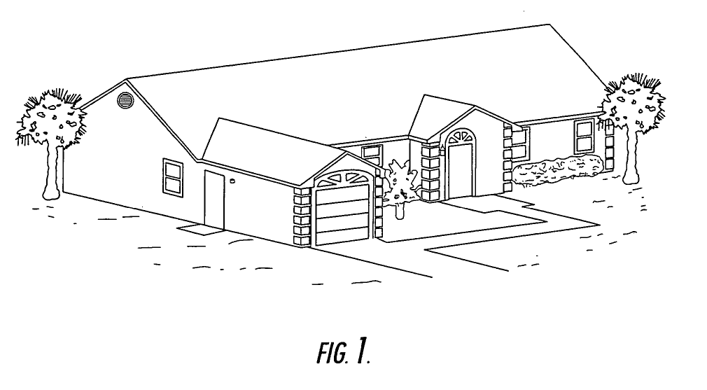

FIG. 1 is a perspective view of an exemplary building or structure that can be acquired and constructed in accordance with one aspect of the invention. In this particular example, the building is a four-bedroom home.

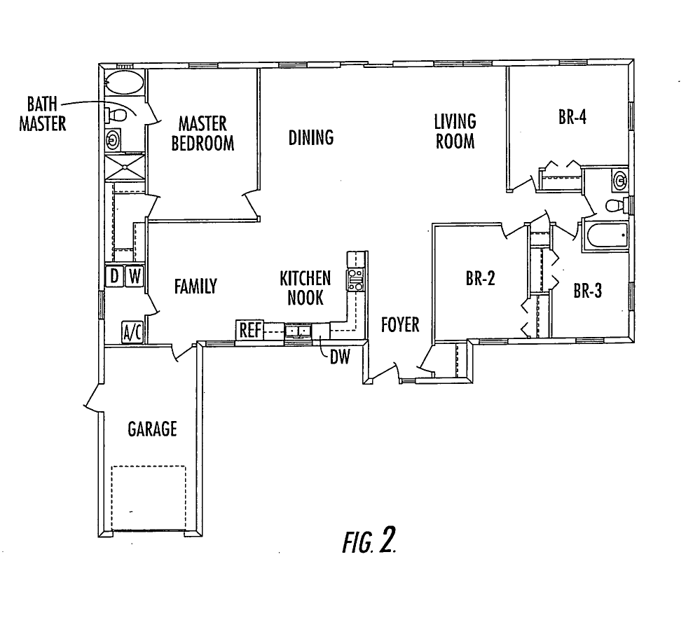

FIG. 2 is an exemplary floor plan of the building of FIG. 1. In the figure shown, entrance through a foyer is into dining room and living room areas. A family room and a kitchen nook are to the left as well as the entrance to a master bedroom. The master bedroom has a master bath and three additional bedrooms and a bath are located by turning right prior to entry into the living room space. A garage is accessible both from the outside, from the family room and through a garage door. A utility room is accessible from the family room.

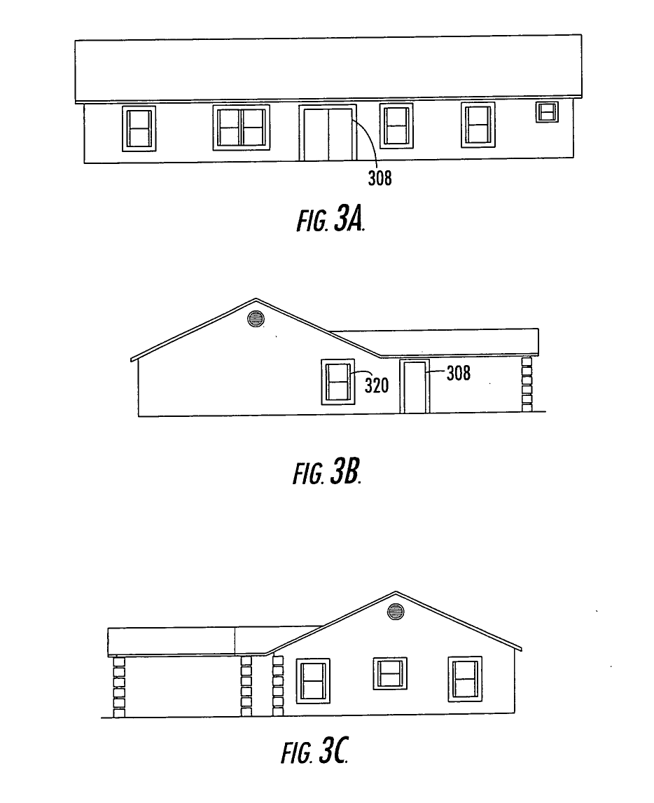

FIGS. 3A, 3B and 3C are respective rear, left and right elevation views of the building of FIG. 1. In FIG. 3A, the entrance from the rear of the building into the home is into the dining room, living room space through double sliding glass doors 300. In FIG. 3B, the entrances in to the garage through the door labeled 310. The window 320 looks out from a utility room containing washer and dryer and air conditioning unit which is accessible from the family room. In FIG. 3C, the three windows represent respectively the view from bedroom 3, the secondary bathroom and the view from bedroom 4.

One can see from the extensive nature of the construction illustrated that an average “Do-It-Yourself” customer would be loath to undertake a construction project of that magnitude without substantial experience in the construction industry.

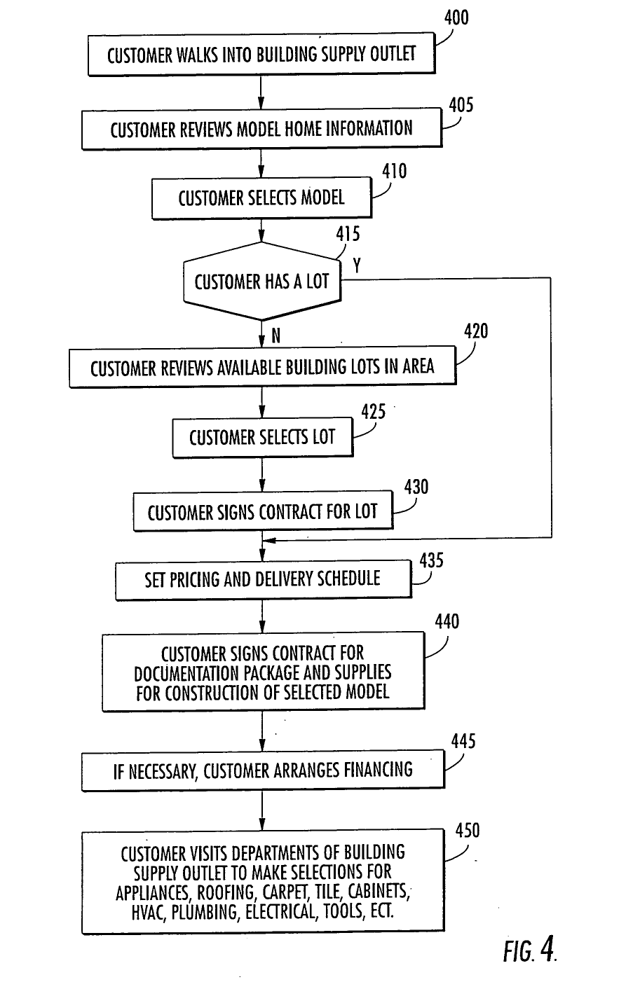

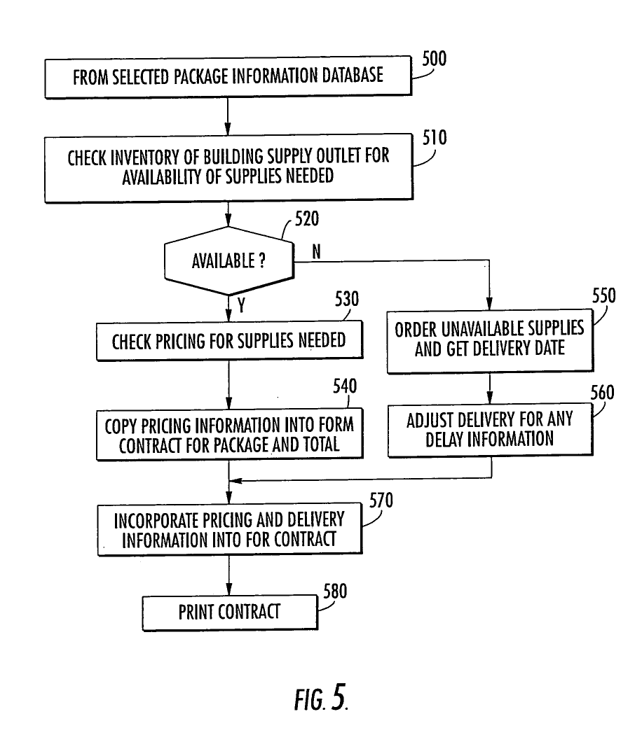

FIG. 4 is a high level flow chart of an exemplary process for enabling building construction for a customer in accordance with one aspect of the invention.

In the example shown in FIG. 4, the marketing of the home construction package begins when a customer walks in to a building supply outlet, such as a Home Improvement Center such as Home Depot® (400). In one implementation of the invention, the customer encounters a display area, such as a kiosk which has model home information. The customer reviews the model home information (405) and selects a model that fits the customers' needs (410).

It maybe that customer already has a lot on which he wishes to construct a building or structure. If that is not the case (415-N) the customer can review information on available building lots in the area. This information may include actual images of the lots, selling price, and other relevant information (420). The customer then selects a lot (425) if the customer wishes, (425) and signs an offer for a contract to purchase the lot (430). This may be based on the images presented to the customer at the kiosk or may be based on an actual visit to one or more lots in the area. It is advantageous but not required that the sales representative interacting with the customer is a licensed real-estate agent. That greatly facilitates the consummation of a contract and the settlement process for the customers' acquisition of the lot.

If the customer already has a lot (415-Y) steps 420, 425 and 430 are omitted.

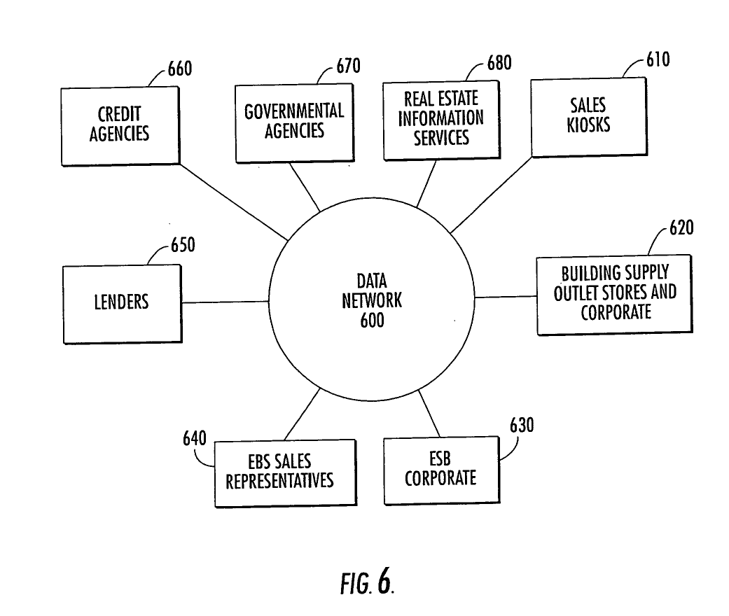

Once the model and the lots have been selected, enough information is available to set the pricing and delivery schedule (435). This is described more in detail and conjunction with FIG. 5.

At this point, the customer is in a position to sign a contract for the documentation package and for the supplies for construction of the selected model.

If desired, the customer can arrange financing directly at the kiosk (445).

Once contracting and financing have been arranged, a customer may visit the various departments of the building supply outlet to make selections for appliances, roofing, carpet, tile, cabinets, heating ventilation and air-conditioning equipment, plumbing and electrical fixtures and optionally tools (450).

A number of the activities described in conjunction with FIG. 4 are or can be computer assisted. For example, the customer may review model home information by viewing models on a computer screen available for such displays. This can be an on-going slide show like presentation that can be interrupted by the user to consider a particular model in more detail. In addition, the customer can review images of actual homes of a particular model type fully constructed in their as-built condition.

Similarly, activities associated with viewing available building lots in the area of the building supply outlet and for the contract negotiation and execution can be facilitated by modern telecommunication capabilities available in the kiosk. For example, images and information on available building lots in the area might be electronically accessible from a multiple listings service. As another example, the customer may permit his credits to be checked online by connection to a credit bureau and may make the unnecessary financing arrangements by linking directly to lenders willing to finance construction projects of this nature.

The visit to the various departments of the building supply outlet may occur by simply visiting the departments or may occur virtually by selecting desirable appliances and materials from virtual presentations available on the computer.

FIG. 5 is a flow chart of a process for carrying out step 435 of FIG. 4.

From the selected package information contained in the database for a selected particular model (500), and preferably using a link to the inventory control system for the building supply outlet at which the kiosk is located, a check is made of the availability of the supplies needed to construct the model selected (510). If the supplies are available (520-Y) the pricing for the individual supplies needed is checked using the local building supply outlet computer system and pricing information from the local building supply outlet computer system is incorporated in to the form contract for the package and a total contract price for building supplies is calculated (540).

If all building supplies are not available (520-N) orders are placed for the unavailable supplies and delivery dates are received from the supplier. These delivery dates are incorporated into calculations for adjusting the delivery schedule to accommodate any delays in the actual arrival of the items ordered (560). With the adjusted delivery schedule and with the pricing information, included in the form contract (570) the contract can be printed and executed by the purchaser.

FIG. 6 is an exemplary network architecture in accordance with one aspect of the invention. The data network (600) connects individual sales kiosks 610 and individual sales representative 640 with the Easy Build Structures corporate network presence of the company providing the design and documentation package, (referred to for convenience as Easy Build Structures) The network presence, as discussed more in after, may include a database of all of the information needed to service customers. The data network itself may consist of either proprietary or public data networks, such as the Internet.

The computer systems maintained by building supply outlet stores and building supply outlet organizations 620 will also communicate over the data network both with individual sales locations and representatives as well as with the main database of supply information maintained by Easy Build Structures shown at 630. As discussed hereinafter, this enables substantially instantaneous pricing of models, given current pricing data from the building supply outlet store that will be utilized to provision the construction project.

From sales kiosk locations or individual sales representative locations, a customer's application for credit can be reviewed, credit reports obtained from credit agencies 660 and loan applications processed through lenders 650. In addition, sales associates can access a variety of governmental agencies 670 in order to obtain information relating to the permitting process in order to better assist their customers. In fact, on-line permit applications can be submitted electronically in some situations. In addition, sales associates can access real-estate information sources such as multiple listing service 680 over the network. In short, the sales associates may access over the data network any on-line data system to cover any need associated with the building construction process.

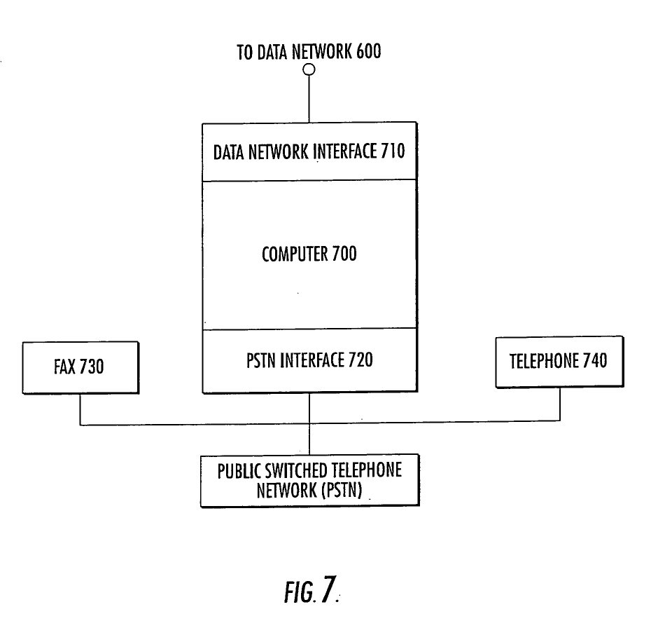

FIG. 7 is an exemplary computer architecture for use in implementing a kiosk or a corporate computer. The purpose of a sales kiosk within a building supply outlet store is to allow a convenient point of access to al information associated with the purchase of a construction package. In one exemplary embodiment, the kiosk is equipped with a computer 700 that is provided with access to data network 600 over a data network interface 710. The computer 700 is also connected to a public switched telephone network (PSTN) 750 over a public switch telephone network interface 720. Telephone (740) and fax (730) access to and from the kiosk occurs over the public switch telephone network (750). As is common with most computer systems, the fax machine and the telephone machine are linked to the computer and maybe controlled from the computer. The fax machine 730 may, in common fashion, also serve as a printing device for the computer. The computer 700 contains one or more display devices (not shown), one of which may be used for user access and the other of which maybe utilized for ongoing display of advertising information dynamically to customers as they pass the kiosk.

The particular software configuration utilized for a computer of the type shown in FIG. 7 will vary depending to some extent on the use. A typical corporate software suite would include, preferably, Alpine View Version 4, Auto Cad LT 1997, Adobe Photo Shop 6.0, Microsoft Publisher 2000, Microsoft Access 2000, Microsoft Excel 2000, and Microsoft Word 2000.

Some of the principal uses for the computer arrangement shown in FIG. 7 include access to local vacant land listings, access to local contractors, access to outlet recommended sub-contractors, access to all design information, access to lenders, access to credit agencies, access to at least the local store of the building supply outlet inventory and pricing systems, and access to governmental agencies.

The representative manning a kiosk in a store would typically be trained in the Easy Build Structures products and services available and have construction experience. Optionally, the representative should be a licensed real-estate agent or broker. The representative can be trained in the local store greeter functions and, during idle time serve as a greeter to customers for the store whether or not the actual employer of the representative is Easy Build Strictures or the building supply outlet store itself.

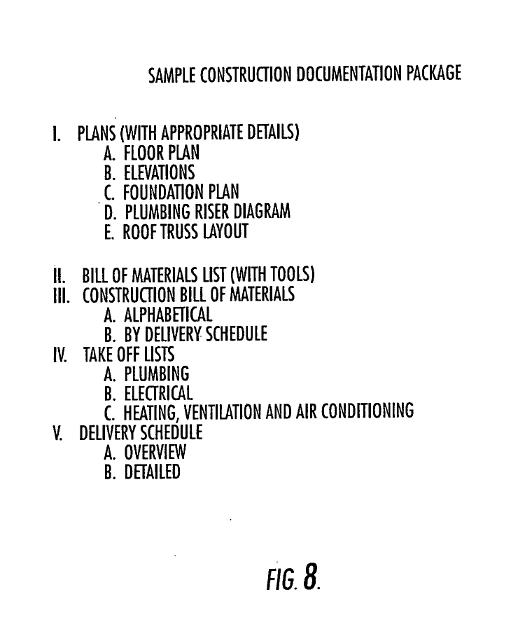

FIG. 8 illustrates an exemplary package of documentation materials provided to a customer for construction of a building or structure such as that shown in FIG. 1.

A typical package would contain a plurality of building plans. These would include elevations, foundation plans, plumbing riser diagrams, floor plans, roof truss layout and all appropriate design details. A bill of materials is also provided including a list of tools needed in order to construct the building selected. The construction bill of material can be arranged both alphabetically and by delivery schedule. A plurality of take off lists can be provided, including plumbing, electrical and heating ventilation and air-conditioning take off lists. The package and materials will also include a delivery schedule overview.

FIG. 9 illustrates an exemplary database containing information on a plurality of structures and indicating certain views of data contained in a structure's portion of the database. The database 900 contains, or can be viewed as if it contained a plurality of sub areas 910 and 920, each pertaining to a respective building structure. From the information stored in the database 900, all of the information needed for generating the construction package referred to in FIG. 8, is generated. Commonly, each of the components of the package for the building structure are produced as views of the data contained in the portion of the database allocated to the structure, such as, for example, the portion allocated to structure 1 shown in item 910 of FIG. 9.

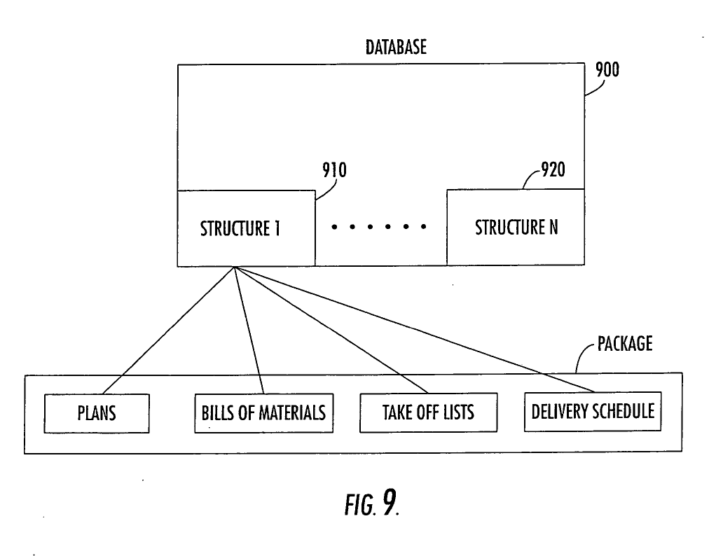

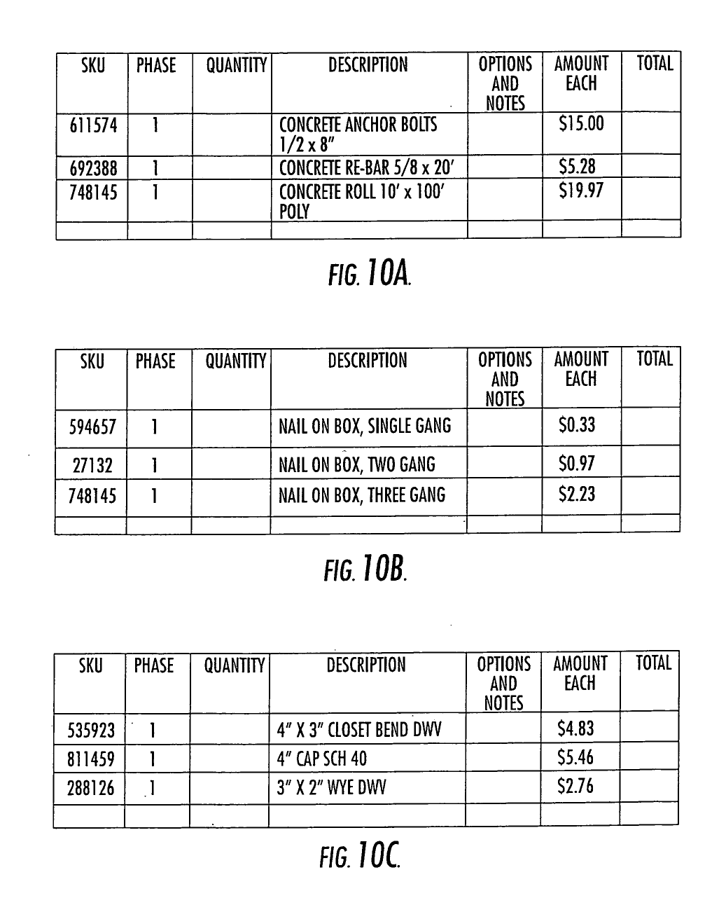

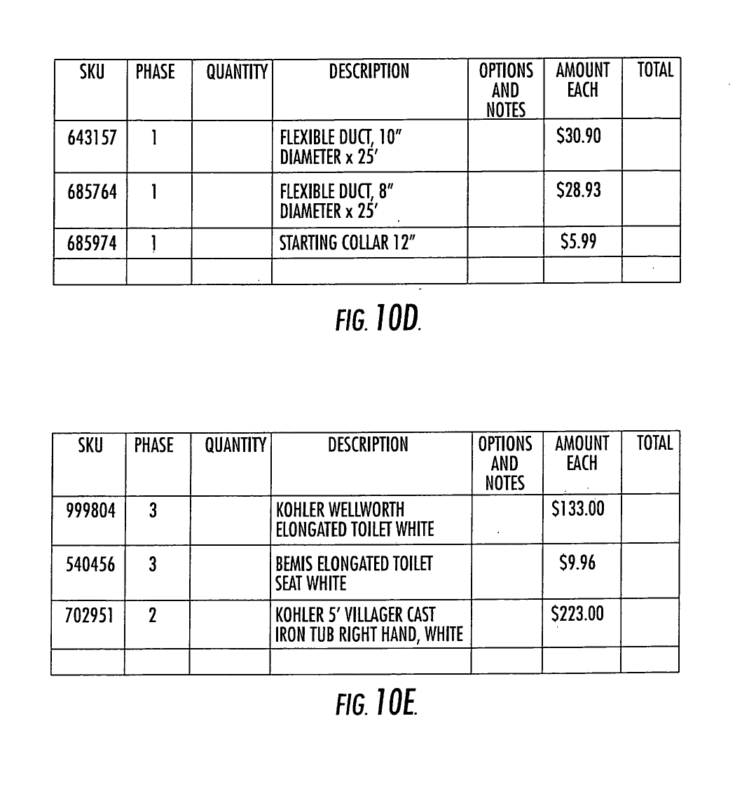

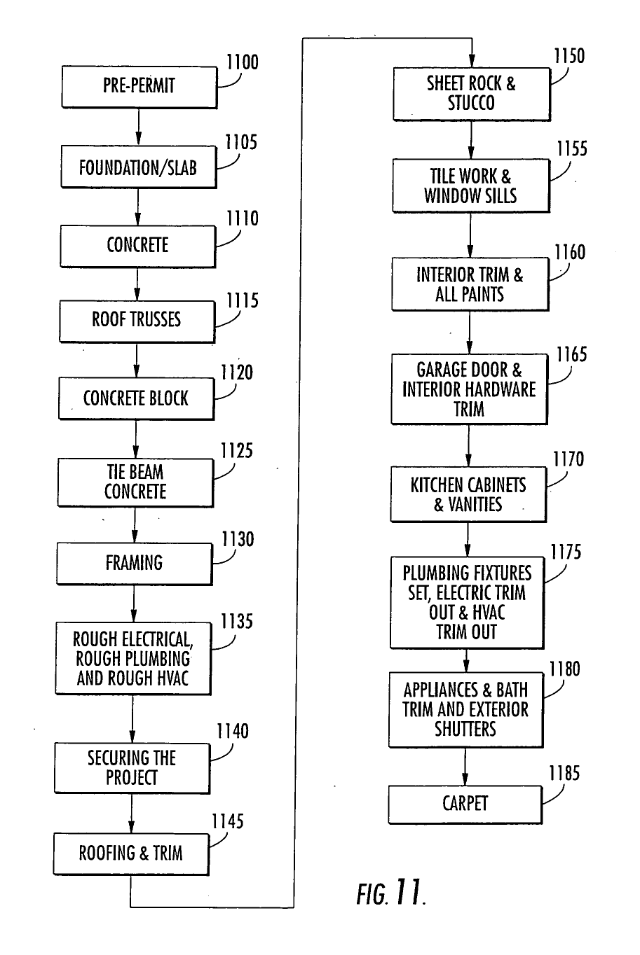

FIGS. 10A, 10B, 10C, 10D and 10E are respective examples of data views used in different reports taken from the database illustrated in FIG. 9. FIG. 10A shows sample entries from a construction take off detail. FIG. 10B shows sample entries from an electrical take off detail. FIG. 10C shows sample entries from a plumbing take off detail and FIG. 10D shows sample entries from a heating, ventilation and air-conditioning (HVAC) take off detail. FIG. 10E shows sample entries from a fixture schedule.

FIG. 11 is a flow chart of an exemplary delivery schedule for materials needed to build the structure in accordance with one aspect of the invention. In an exemplary embodiment, the delivery schedule comprises eighteen individual deliveries.

The first delivery is the Pre-Permit stage. This generally occurs at the kiosk and includes delivery of engineering plans, the material option list, the certification papers including material and component specifications and a construction “How-To” book.

The second delivery (1105) is directed to the concrete foundation and slab preparation. It includes, for example, form boards, stakes and nails, Visqueen, rebar, chairs, ties and wire mesh, anchor bolts, under slab plumbing (if ordered) and under slab electrical (if required or if ordered).

The deliveries three and four include ready mixed concrete (1110) and roof trusses (1115).

Delivery five is the concrete block delivery (1120). It includes the delivery of block, header and lintel block, window sills, mortar mix, sand, rebar and ties and tie downs and connectors.

Delivery six (1125) includes tie beam concrete.

The seventh delivery (1130) is the framing delivery and includes the delivery of lumber, plywood, nails, dry-in tarpaper and/or house wrap, foil installation for block walls and BCI and LVL'S (if required).

The eighth delivery (1135) includes the materials needed for rough electrical, rough plumbing and rough HVAC.

The ninth delivery (1140) includes materials needed for securing the construction project and includes the delivery of exterior doors, windows and fasteners.

The tenth delivery (1145) includes materials needed for roofing and trim. This includes shingles, drip edge, fascia, soffit and nails.

The eleventh delivery (1150) includes the materials needed for sheet rock and stucco. This specifically includes delivery of dry wall, green board and backer board, dry wall compound, corner bead, dry wall fasteners, stucco mix, stucco sand, plastic stucco stop, expanded metal lath and fasteners.

The twelfth delivery (1155) includes material needed for tile work and windowsills includes floor and bath tile, thin set and gout and marble sills.

The thirteenth delivery (1160) includes materials needed for interior trim and all paints. It includes, for example, interior doors, baseboard, interior and exterior paints, stair rail, balusters, and hardware (if required).

The fourteenth delivery (1165) includes the garage door and interior hardware trim. The garage door and opener, door locks and stops, shelving and hardware are delivered in this delivery.

The fifteenth (1170) and sixteenth (1175) deliveries cover respectively kitchen cabinets and vanities and plumbing fixture set, electrical trim out and HVAC trim out.

The next to the last delivery (1180) is directed to appliance and bathroom and exterior shutters. The delivery includes appliances, bath mirrors, towel bars, shower doors and alike, shutters and hardware to mount each of these.

The eighteenth and final delivery (1185) includes everything needed for installation of carpet, such as carpet and pad, gripper and tack.

By staging the delivery of equipment and supplies in this manner, storage problems are eliminated and losses by theft from the construction project can be minimized, since only the materials needed for construction in the next immediate period of time will be available on the site.

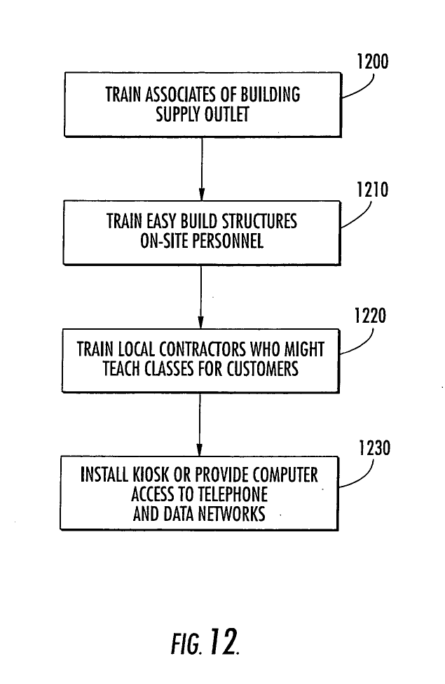

FIG. 12 is a flow chart of an exemplary process for opening a new store. One particularly nice feature of the techniques described herein is the fact that once the system is developed for a single store, they maybe rapidly deployed to additional stores with a minimal of effort. Since data from the local building supply outlets' inventory and pricing systems is incorporated with building model information from the master database 900, a package that is personalized to the local store becomes easy. Propagating the Easy Build System to a new store can be easily produced then becomes an easy process. First, one trains the associates of the building supply outlet to the extent needed for them to interact with the personnel of the Easy Build kiosk and with customers' questions (1200). One needs to train the Easy Build Structure on-site personnel (1210) in the use of the computer systems and the culture of the organization. One would also train local contractors who might be interested teaching classes for customers (1220). Such classes would likely be a source of work for the contractors. Finally, the kiosk is installed and equipment is connected to appropriate telephone and data networks. Note that this easy installation is even more simplified if one chooses to utilize wireless access to a data or a telephone network or both. Then no wiring is required.

The experience of a particular “Do-It-Yourself” customer may be specialized. For example, the customer may have experience in roofing but not in laying concrete block. The staging of deliveries and the selective use of sub-contractors enable the “Do-It-Yourself” customer to adjust to the experience needed in particular areas where he feels a particular lack. For example, some building supply outlets, such as Home Depot® have a plurality of approved sub-contractors for certain specialized installations. For example, one sub-contractor might specialize in installing cabinets. Another might specialize in the installation of ceramic tile. These contractors have been previously approved by the building supply outlet and are known for their capability and willingness to stand behind their work. In addition, a variety of general contractors might be willing to supervise the work of sub-contractors at a reasonable cost. Thus, the “Do-It-Yourself” customer has available by the combined association of the Easy Build Structures organization with the building supply outlet, the full set of capabilities to apply to producing a quality construction project. To the extent that the customer's skills permit, the customer could build the structure entirely on his own using the construction package and materials provided as described herein.

The benefits of the invention described herein enable even contractors, who build structures for a living, to increase their profit margins by buying construction documentation and supplies in the manner described above.

There has thus been described in some detail computer assisted systems and techniques for overcoming the problems of the prior art, and for enabling individuals less skilled in construction to construct, or to supervise the construction by sub-contractors of a complex building project. Much if not all of the logistical problems associated with the complicated construction project have been solved in advance thus seriously simplifying the process to a point where a construction can be undertaken by a person with “Do-It-Yourself” experience. In addition, the building supply outlets acquire a new class of customers which increases their sales volume. The customer benefits because, through the use of standardized components, the costs for building one of the models is substantially below market rates.

Although the exemplary embodiments have been disclosed herein, the scope of the invention is not limited thereto but rather is expressed in the claims set forth hereinafter.

What is claimed

1. A method of selling structures from an outlet for building supplies, comprising the steps of:
a. providing at least one package of documentation needed for construction of a structure on a lot, and
b. providing substantially all supplies needed for said construction through said outlet.

2. The method of claim 1 in which a plurality of packages are provided, each corresponding to a respective structure design.

3. The method of claim 2 further comprising the step of providing visual information about the appearance after construction of at least one structure design.

4. The method of claim 1 in which said outlet is a retail outlet.

5. The method of claim 1 in which said outlet is a Home Improvement Center.

6. The method of claim 1, further comprising the step of providing, in said outlet, a selection of lots available for construction in the vicinity of said outlet.

7. The method of claim 1 further comprising the step of providing training to customers of said outlet in how to carry out construction of said structure.

8. The method of claim 1 further comprising the step of providing training to contractors on how to train customers of said outlet in how to carry out construction of said structure.

9. The method of claim 1 further comprising the step of providing all tools needed for said construction in said outlet.

10. The method of claim 1 further comprising the step of marking products in said outlet that are listed in a package for the construction of a structure with a label indicating that they are used with construction of such structures.

11. A method for selling structures, comprising the steps of:
a. configuring a computer to have access to a database containing at least one package of documentation needed for construction of a structure on a lot, and
b. retrieving inventory or pricing information over a network from a building supply outlet, and
c. incorporating said information into said package of documentation.

12. A system for selling structures, comprising:
a. a computer configured to have access to a database containing at least one package of documentation needed for construction of a structure on a lot, and
b. a computer associated with a building supply outlet storing at least one of inventory information and pricing information on products for sale at said building supply outlet, and
c. a network over which said computer having access to a database can access inventory or pricing information and incorporate said information into said package of documentation.

13. A computer used in the selling of structures, comprising:
a. a mechanism for accessing a database containing at least one package of documentation needed for construction of a structure on a lot, and
b. a mechanism for retrieving inventory or pricing information over a network from a building supply outlet, and
c. a mechanism for incorporating said information into said package of documentation.

14. A computer program product comprising:
a. a storage medium, and
b. a computer program, stored on said storage medium, said computer program comprising instructions for accessing a database containing at least one package of documentation needed for construction of a structure on a lot.

15. The computer program product of claim 14, in which said computer program further comprises instructions for retrieving inventory or pricing information over a network from a building supply outlet, and for incorporating said information into said package of documentation.
